(19) United States
(12) Patent Application Publication
(10) Pub. No.: US 2005/0228152 A1
(43) Pub. Date: Oct. 13, 2005

(54) Anti-reflective coating

(76) Inventors: Adam B. Starry, Vienna, WV (US); Hanxing Zheng, Parkersburg, WV (US); Rutger D. Puts, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/100,115

(22) Filed: Apr. 6, 2005

Related U.S. Application Data
(60) Provisional application No. 60/560,683, filed on Apr. 8, 2004.

(51) Int. Cl. C08F 16/24

(52) U.S. Cl. 526/247; 526/266; 526/270

(57) ABSTRACT

The present invention relates to an anti-reflective coating for an optical substrate. The anti-reflective coating is an amorphous fluoropolymer containing at least one functionalized repeating unit selected from a.) —[CF₂CF(OCF₂CF(CF₃)OCF₂CF₂CH₂Z)]—, wherein Z can be —OH, —OP(═O)(OH)₂, and —OC(═O)NH₂, and b.) —[CH₂CH(OR¹)]—, wherein R¹ is at selected from H and —C(═O)R². The functionalized repeating unit increases the adhesion of the amorphous fluoropolymer to the substrate.

### BACKGROUND OF THE INVENTION

1. Field of the Invention

The present invention relates to the field of anti-reflective coatings for reducing reflections from the surface of optical articles, such as displays, optical lenses, windows, optical polarizers, transparent films, glossy photographs and the like. More specifically, it relates to antireflective coatings of amorphous fluoropolymers containing certain functionalized repeating units, said coatings having low refractive index and good adhesion properties.

2. Description of Related Art

Optical materials are characterized by their refractive index “n”. Whenever light travels from one material to another of different index, some of the light is reflected. For example, when light travels from air, where n=1, into glass, where typically n=1.5, about 4 percent is reflected. For displays such as PDP (Plasma Display Panel) and LCD (Liquid Crystal Display) etc., reflections reduce the brightness, contrast and resolution of the image. For microlithography, as the microelectronics industry has reduced the line-width requirements for new devices, the effects of substrate reflectivity increase dramatically in proportion to the line widths being patterned. For example, a 0.25 μm reflective notch that may be acceptable on a 1.2 μm device will produce a complete open on a 0.3 μm device. Reflected light is also associated with a loss of transmitted light. For components such as compound lenses, reflection on each interface between layers of the lenses amounts to substantial internal stray light, which seriously reduces image contrast. Moreover, the loss of the transmitted light due to reflection can add up and become very significant.

Unwanted reflections can be substantially reduced by providing an anti-reflective coating on the surface of an optical article at a specified thickness. For an optical article with refractive index n, in order to reach the maximum effectiveness, the coating should have the optical thickness (the physical thickness multiplied by its own refractive index) about a quarter of the wavelength of the incoming light and have a refractive index of the square root of n. Most optical articles have refractive index ranging from 1.4 to 1.6.

Fluoropolymers are known to have a low refractive index. However, they also have very poor adhesion to common substrates like plastics and glass. Various modifications have been made in order to improve their adhesion to a substrate. For instance, U.S. Pat. No. 5,510,406, relies on the use of a coupling group in a polymer having a fluorine-containing cycloaliphatic structure which is used as an anti-reflective coating. The coupling group allows adhesion to the substrate without losing transparency. As disclosed on column 6, lines 48-59 of this patent, when the amount of the coupling group is too small, the adhesivity is not satisfactorily improved. On the other hand, when the amount of the coupling group is too large, the original properties of the fluoropolymer are degraded and the stability of the coating solution becomes poor, resulting in gelation. Thus, there is a need to develop a coating which does not use a such a coupling group, as this may cause instability of the solution.

Coatings made from a fluoropolymer comprising vinylidene fluoride are disclosed in published PCT Application WO 00/55130. However, such fluoropolymers have a glass transition temperature which is below room temperature. Consequently, such fluoropolymers are soft at room temperature, and have low abrasion resistance.

European Patent Application 0 778 476 A2 discloses an anti-reflection film formed of fine fluororesin particles. The fluororesin particles have functional groups (reactive groups), and the particles can be bonded by reaction between the functional groups. The particles of the film are deposited so as to superpose the particles on each other, to form micro voids surrounded by the particles. These micro voids are physical voids, that is, interruptions in the physical continuity of the polymer that makes up the coating. Such voids have a physical location that is fixed with relation to the other components of the void-containing structure. It would be desirable to have a simpler coating system which does not depend on the superposition of particles or the formation of such micro voids.

### BRIEF SUMMARY OF THE INVENTION

The present invention overcomes the problems associated with the prior art by using an amorphous fluoropolymer containing certain functionalized repeating units as an anti-reflective coating. The anti-reflective coating has good adhesion properties, and is more durable than the coatings disclosed in the prior art. In addition, the anti-reflective coating does not depend on the use of coupling agents to enhance adhesion, which leads to a more stable fluoropolymer solution. At the same time, the anti-reflective coating is a uniform, void-free layer, which is a simpler system than coatings of the prior art.

Therefore, in accordance with the present invention, there is provided an anti-reflective coating comprising amorphous fluoropolymer, wherein said amorphous fluoropolymer contains at least one functionalized repeating unit selected from a.) —[CF₂CF(OCF₂CF(CF₃)OCF₂CF₂CH₂Z)]—, wherein Z is at least one of —OH, —OP(═O)(OH)₂, and —OC(═O)NH₂, and b.) —[CH₂CH(OR¹)]—, wherein R¹ is at least one selected from H and —C(═O)R², wherein R² is C₁-C₃ hydrocarbyl.

### DETAILED DESCRIPTION OF THE INVENTION

The present invention is an anti-reflective film comprising amorphous fluoropolymer, wherein said fluoropolymer contains at least one functionalized repeating unit. Without wishing to be bound by theory, it is believed that the functionalized repeating unit imparts to the amorphous fluoropolymer sufficient polarity to promote adhesion to substrates.

Functionalized repeating units of the present invention are selected from the group consisting of: a.) —[CF₂CF(OCF₂CF(CF₃)OCF₂CF₂CH₂Z)]—, wherein Z is at least one selected from the group consisting of —OH, —OP(═O)(OH)₂, and —OC(═O)NH₂, and b.) —[CH₂CH(OR¹)]—, wherein R¹ is at least one selected from the group consisting of H and —C(═O)R², wherein R² is C₁-C₃ hydrocarbyl. Specific examples of monomers giving rise to functional repeating units of the type —[CF₂CF(OCF₂CF(CF₃)OCF₂CF₂CH₂Z)]— are 9,9-dihydro-9-hydroxyperfluoro(3,6-dioxa-5-methyl-1-nonene) (hereinafter alternately referred to as EVE-OH), 9-phosphono-9,9-dihydro-perfluoro(3,6-dioxa-5-methyl-nonene) (hereinafter alternately referred to as EVE-P), and 9-carbamate-9,9-dihydro-perfluoro(3,6-dioxa-5-methyl-1-nonene) (hereinafter alternately referred to as EVE-carbamate). Unfluorinated monomers giving rise to functional repeating units of the type —[CH₂CH(OR¹)]— may also be used to introduce functionality. An example is vinyl acetate, which, after copolymerization, can be hydrolyzed to give functionality to the polymer via the resulting pendant —OH group.

In one embodiment, amorphous fluoropolymer of this invention includes repeating units arising from the monomer perfluoro-2,2-dimethyl-1,3-dioxole (hereinafter alternately referred to as PDD). The present invention includes a substrate polymer sheet or film having on at least one of its faces a coating of an amorphous copolymer containing repeating units arising from 58-99 mole % of the monomer PDD and tetrafluoroethylene (herein alternately referred to as TEF) and at least one functional comonomer selected f EVE-OH, EVE-P, EVE-carbamate, and vinyl acetate which give rise to functional repeating units of the type —[CF₂CF(OCF₂CF(CF₃)OCF₂CF₂CH₂Z)] defined hereinabove. The polymers of the present invention can be synthesized by known radical polymerization methods using known radical initiators such as hexafluoropropylene (HFPO) dimer peroxide (CF₃CF₂CF₂OCF(CF₃)C(═O)O)₂. When vinyl acetate is used as a comonomer, the acetate ester groups in the resulting polymer can be hydrolyzed to hydroxyl groups.

Many fluoropolymers such as polytetrafluoroethylene (PTFE), copolymers of tetrafluoroethylene and perfluoro(alkyl vinyl) ethers (PFA) etc. have a crystalline structure, whereby light scattering occurs and the transparency is poor. Fluoropolymers of this invention are amorphous to avoid such problems. The term “amorphous fluoropolymer” as used herein means a room temperature solid polymer having a fluorine-bearing carbon-to-carbon back bone chain containing carbon, fluorine and hydrogen, and possibly oxygen, and which is amorphous as determined by X-ray diffraction, as described in U.S. Pat. No. 5,139,879 to Aharoni et al. Amorphous fluoropolymers and methods for their synthesis are known and commercially available products. They are, for example, available from E.I. du Pont de Nemours and Company (DuPont) under the designation “Teflon AF”™. These fluoropolymers sold by DuPont include copolymers of TFE with PDD.

Amorphous fluoropolymers of the present invention have a glass transition temperature of at least about 50° C., preferably at least about 65° C., and more preferably, at least about 80° C.

The amorphous fluoropolymers of the present invention preferably have repeating units of fluorine-containing cycloaliphatic structure, examples of which are illustrated by the following general formulas: 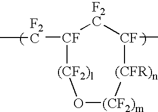
wherein l is an integer from 0 to 5, m is an integer from 0 to 4, n is 0 to 1, l+m+n is an integer from 1 to 6 and R is F or CF₃; 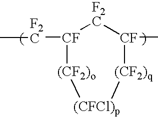
wherein each of o, p and q is an integer from 0 to 5 and o+p+q is an integer from 1 to 6; and 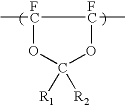
wherein R₁ is F, CF₃ or CF₂CF₃ and independently R₂ is F, CF₃ or CF₂CF₃. Preferred amongst the fluorine-containing cycloaliphatic structures is:

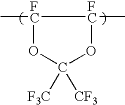

The amorphous fluoropolymers of the present invention having fluorine-containing cycloaliphatic structures have low refractive index, good mechanical and solubility characteristics while retaining the outstanding chemical, thermal and surface properties associated with fluoropolymers. This combination of properties makes them unique for the anti-reflective coating application.

The amorphous fluoropolymers of this invention comprise from about 0.1 to about 30 mole percent functionalized repeating unit selected from —[CF₂CF(OCF₂CF(CF₃)OCF₂CF₂CH₂Z)]— and —[CH₂CH(OR¹)]—, preferably from about 1 to about 30 mole percent, more preferably from about 2 to about 25 mole percent, still more preferably from about 5 to about 20 mole percent, and most preferably from about 10 to about 15 mole percent.

The cycloaliphatic monomer comprises about 40 to 90 mole percent, preferably about 50 to 90 mole percent. TFE is a preferred additional monomer in the present amorphous fluoropolymer.

The present anti-reflective coating is a uniform, void-free layer. By void-free is meant that the antireflective coating contains substantially no physical voids, that is, interruptions in the physical continuity of the polymer that makes up the coating.

The present anti-reflective coatings can be prepared by dissolving the amorphous fluoropolymer in a suitable solvent, such as, for example, the family of fluorinated solvents sold by Minnesota Mining and Manufacturing Company (3M) under the trademark Fluorinert®, e.g., perfluorotributylamine, sold under the designation FC-40. The fluoropolymer solution is then coated onto desired substrates. Any conventional method may be used to coat the substrates including gravure, microgravure, and slot die coating, as well as brushing, spraying, spin-casting, dipping or printing. The coated substrates can be heated in an oven at elevated temperature to remove the solvent.

The present anti-reflective coatings should have the optical thickness (the physical thickness multiplied by its own refractive index) about a quarter of the wavelength of the incoming light. For most applications, the optimal anti-reflective coating can be obtained by making the optical thickness one quarter of the mid-point of the visible wavelength range. This corresponds to the optical thickness of about 138 nm. Considering the refractive index of the amorphous fluoropolymers of this invention (i.e., amorphous fluoropolymers having cyclo-aliphatic structures with a refractive index of about 1.32), the optimal coating thickness is about 104 nm. Generally, the thickness of the coating is from about 95 to about 105 nm, preferably about 100 nm.

The surface of the substrate may be pre-treated before the anti-reflective coating is applied to the substrate. One example is that plastic films like TAC (triacetyl cellulose) and PET (polyethylene terephthalate) usually have hard polyacrylate coats on them. Or, for example, plastic films can be pre-treated by plasma or corona treating for better adhesion.

The present invention includes a composite structure comprising a substrate and the hereinabove described amorphous fluoropolymer coating deposited on at least one surface thereof. Substrates used in this invention for anti-reflective coating can form optical articles such as display surfaces, optical lenses, windows, optical polarizers, optical filters, glossy prints and photographs, clear polymer films, and the like. Substrates of the present invention include polyacrylates, polymethacrylates, poly(C₁-C₁₂)alkyl methacrylates, polyoxy(alkylene methacrylates), poly (alkoxylated phenol methacrylates), cellulose acetate, cellulose triacetate, cellulose acetate propionate, cellulose acetate butyrate, poly(vinyl acetate), poly(vinyl alcohol), poly(vinyl chloride), poly(vinylidene chloride), thermoplastic polycarbonates, polyesters, polyurethanes, poly(ethylene terephthalate), polystyrene, poly(alpha methylstyrene), copoly(styrene-methylmethacrylate), copoly(styrene-acrylonitrile), polyvinylbutyral and polymers of members of the group consisting of polyol(allyl carbonate) monomers, polyfunctional acrylate monomers, polyfunctional methacrylate monomers, diethylene glycol dimethacrylate monomers, diisopropenyl benzene monomers, alkoxylated polyhydric alcohol monomers and diallylidene pentaerythritol monomers. Preferred substrates are triacetyl cellulose, polyester, polycarbonate, polymethylmethacrylate, polyacrylate and glass.

### EXAMPLES

In the following examples, HFPO dimer peroxide is bis[2,3,3,3-tetrafluoro-2-(heptafluoropropoxy)-1-oxopropyl]peroxide, Vertrel® XF is 1,1,1,2,2,3,4,5,5,5-decafluoro pentane and is available from DuPont, and FC-40 is perfluorotributylamine, a fluorinated solvent available from 3M as Fluorinert®. PDD, TFE, EVE-P, vinyl acetate, and EVE-carbamate are as described above. The “EVE” comonomers can be made by the method disclosed in U.S. Pat. No. 6,166,138.

### Example 1

A 210 ml stainless steel shaker tube is chilled to below −20° C. and loaded with 2 g of EVE-OH dissolved in 50 ml of Vertrel® D XF, 24.4 g of PDD, and 10 ml of 0.17 M HFPO dimer peroxide in Vertrel XF. The tube is chilled again and 10 g of TFE is added. The tube is shaken overnight at room temperature reaching a maximum pressure of 51 psi at 13.4° C. and finishing about 18 hours later at 14.1 psi at 33.3° C. The resulting slightly-hazy, highly-viscous solution is blown down with N₂, subjected to 30 hours of pump vacuum, and then finished for 10 days in a 67° C. vacuum oven with a slight N₂ bleed. This generates 30.07 g of polymer, soluble in FC-40, with a composition of 51 mole percent of PDD, 48 mole percent of TFE, 1 mole percent of EVE-OH by fluorine NMR, and with an inherent viscosity of 0.333 in hexafluorobenzene. This polymer has T_{g} at about 106° C.

### Example 2

A 210 ml stainless steel shaker tube is chilled to below −20° C. and loaded with 2 g of EVE-P dissolved in 50 ml of Vertrel XF, 24.4 g of PDD, and 10 ml of 0.17 M HFPO dimer peroxide in Vertrel XF. The tube is chilled again and 10 g of TFE is added. The tube is shaken overnight at room temperature reaching a maximum pressure of 47 psi at 21.4° C. and finishing about 19 hours later at 6.8 psi at 34.1° C. The resulting hazy-white, highly-viscous mixture is blown down with N₂, subjected to 30 hours of pump vacuum, and then finished for 10 days in a 67° C. vacuum oven with a slight N₂ bleed. This generates 27.06 g of polymer, soluble in FC-40, with a composition of 47 mole percent of PDD, 52 mole percent of TFE, 1 mole percent of EVE-P by fluorine NMR, and with an inherent viscosity of 0.370 in hexafluorobenzene. This polymer has a T_{g} at about 101° C.

### Example 3

A round bottom flask equipped with a magnetic stir bar, a serum stopper, and a reflux condenser is flushed with N₂ and then loaded with 100 ml of Vertrel XF, 12.8 ml of vinyl acetate, and 20 ml of PDD. The flask is then changed over from a nitrogen purge to a positive pressure of N₂. Five milliliters of 0.17M HFPO dimer peroxide in Vertrel XF is injected through the serum stopper. Another 5 ml of 0.17 M HFPO dimer peroxide in Vertrel XF is injected after 23 hours. The reaction mixture is stirred for another 10 days at room temperature and then poured into 600 ml of methanol with stirring. The resulting sticky solids are vacuum filtered, washed with 100 ml of methanol, sucked damp dry on the paper filter overnight to get 41.39 g white chunks.

A round bottom flask equipped with a magnetic stir bar is loaded with 14.32 g of the copolymer made above and 114.6 g of methanol. The reaction mixture is stirred as 5.44 g of 45 wt % KOH are added dropwise. Much of the solid polymer appears undissolved after stirring overnight. Stirring is continued for another 2 to 3 days at room temperature after which much of the solid polymer appears dissolved. The mixture is poured into 250 ml of deionized water with agitation. The resulting precipitate is vacuum filtered, washed with water, sucked damp dry on the paper filter, and finally oven dried for 25 hours under pump vacuum. This gives 11.98 g of free-flowing pale yellow crumb.

11.4 g of the yellow crumb generated above are dissolved in 100 ml of acetone and shaken with 1 g silica gel+1 g alumina+1 g Darco decolorizing carbon and then filtered through a 0.45 micron PTFE filter. The resulting yellow solution is added to 500 ml of water in a Waring blender. The resulting precipitate is vacuum filtered, washed with water, sucked damp dry on the paper filter, and finally dried for 24 hours under pump vacuum. This gives 4.6 g of fluffy yellow solid with T_{g} at about 137° C. The copolymer has a composition of 37.4 mole % PDD, 62.6 mole % vinyl alcohol by NMR.

1. An anti-reflective coating comprising amorphous fluoropolymer, wherein said amorphous fluoropolymer contains at least one functionalized repeating unit selected from the group consisting of:
a.) —[CF₂CF(OCF₂CF(CF₃)OCF₂CF₂CH₂Z)]—, wherein Z is at least one selected from the group consisting of —OH, —OP(═O)(OH)₂, and —OC(═O)NH₂, and
b.) —[CH₂CH(OR¹)]—, wherein R¹ is at least one selected from the group consisting of H and —C(═O)R², wherein R² is C₁-C₃ hydrocarbyl.

2. The coating of claim 1 wherein said amorphous fluoropolymer comprises at least one repeating unit selected from the group consisting of:
a.) —[(CF₂)ₕCFX¹(CF₂)ₖCFX²]—, wherein h and k are both either 0 or 1, and X¹ and X² are bonded together and comprise perfluorooxyalkylene or perhaloalkylene, and
b.) —[CFX¹CX²X³]—, wherein X₁-X³ are independently selected from the group consisting of H, F, perfluoroalkyl and perfluorooxyalkyl.

3. The coating of claim 1 wherein said amorphous fluoropolymer comprises at least one repeating unit selected from the group consisting of: —[CH₂CHF]—; —[CH₂CF₂]—; —[CHFCF₂]—; —[CF₂CF₂]—; —[CF₂CF(OCF₃)]—; —[CF₂CF(OC₂F₅)]—; —[CF₂CF(OC₃F₇)]—; 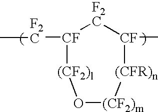
, wherein l is an integer from 0 to 5, m is an integer from 0 to 4, n is 0 or 1, l+m+n is an integer from 1 to 6, and R is F or CF₃; 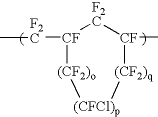
, wherein o, p and q are independently selected from integers from 0 to 5 and o+p+q is an integer from 1 to 6; and
, wherein R₁ and R₂ are independently selected from the group consisting of F, CF₃ and CF₂CF₃.

4. The coating of claim 1, wherein said amorphous fluoropolymer comprises repeating units of —[CF₂CF₂]— and, wherein R₁ and R₂ are CF₃.

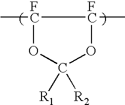

5. The coating of claim 1, wherein said functionalized repeating unit is —[CF₂CF(OCF₂CF(CF₃)OCF₂CF₂CH₂Z)]—, wherein Z is at least one selected from the group consisting of —OH, —OP(═O)(OH)₂, and —OC(=O)NH₂.

6. The coating of claim 1, wherein said functionalized repeating unit is —[CH₂CH(OR¹)]—, wherein R¹ is at least one selected from the group consisting of H and —C(═O)R², wherein R² is C₁-C₃ hydrocarbyl.

7. The coating of claim 6, wherein said functionalized repeating unit is —[CH₂CH(OH)]—.

8. The coating of claim 1 wherein said amorphous fluoropolymer contains from about 0.1 to about 30 mole percent of said functionalized repeating unit.

9. The coating of claim 1 wherein said amorphous fluoropolymer contains from about 2 to about 25 mole percent of said functionalized repeating unit.

10. The coating of claim 1 wherein said amorphous fluoropolymer contains from about 5 to about 20 mole percent of said functionalized repeating unit.

11. The coating of claim 1 wherein said amorphous fluoropolymer contains from about 10 to about 15 mole percent of said functionalized repeating unit.

12. The coating of claim 1 wherein said amorphous fluoropolymer contains from about 40 to 90 mole percent repeating units selected from the group consisting of: 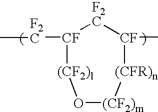
, wherein l is an integer from 0 to 5, m is an integer from 0 to 4, n is 0 or 1, l+m+n is an integer from 1 to 6, and R is F or CF₃; 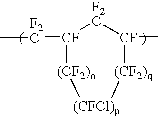
, wherein o, p and q are independently selected from integers from 0 to 5 and o+p+q is an integer from 1 to 6; and 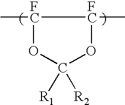
, wherein R₁ and R₂ are independently selected from the group consisting of F, CF₃ and CF₂CF₃.

13. The coating of claim 1 having a thickness of about 100 nanometers.

14. A composite structure comprising a substrate and the coating of claim 1 deposited on at least one surface thereof, wherein said substrate is selected from the group consisting of triacetyl cellulose polymer, polyester, polycarbonate, polymethylmethacrylate, polyacrylate, polyvinyl alcohol, polystyrene, glass, vinyl and nylon.

15. A composite structure comprising a substrate and the coating of claim 1 deposited on at least one surface thereof, wherein said substrate is selected from the group consisting of triacetyl cellulose polymer, polyester, polycarbonate, polymethylmethacrylate and polyacrylate.
